(19) United States
(12) Patent Application Publication
(10) Pub. No.: US 2001/0047261 A1
(43) Pub. Date: Nov. 29, 2001

(54) Partially automated interactive dialog

(76) Inventor: Peter Kassan, New York, NY (US)

Correspondence Address: OSTROLENK FABER GERB & SOFFEN, 1180 AVENUE OF THE AMERICAS, NEW YORK, NY, 100368403

(21) Appl. No.: 09/767,342

(22) Filed: Jan. 22, 2001

Related U.S. Application Data
(60) Provisional application No. 60/177,890, filed on Jan. 24, 2000.

(51) Int. Cl. G10L 11/00

(52) U.S. Cl. 704/270

(57) ABSTRACT

A computer program that provides automated interactive technical support simulating the sort of support an actual human would provide, including a mechanism under which, under certain circumstances, a human being is able to intervene where necessary to supplement or substitute for the automated help. The system has an artificial intelligence engine that uses natural language processing to engage in unrestricted and automated dialogue with callers, modified essentially in that the computer is able to rate the dialogue and when the dialogue quality falls below a predetermined rating threshold, callers are automatically routed to human operators for further intervention and assistance.

### RELATED APPLICATIONS

This Application claims priority and is entitled to the filing date of U.S. Provisional Application Serial No. 60/177,890 filed Jan. 24, 2000, and entitled “PARTIALLY AUTOMATED INTERACTIVE DIALOG,” the contents of the provisional patent application are incorporated by reference herein.

### BACKGROUND OF THE INVENTION

The present invention is generally directed to a system for interacting with a computer and, more particularly, to a partially automated interactive dialog system for interacting with computers to obviate the need to always provide human resources to help answer questions that customers may have to various companies, organizations and the like.

Computer programs; Internet web sites; electronic devices such as VCRs and cameras; household appliances such as washing machines, dishwashers, and ovens; and many other types of hardware and software products are increasingly complicated and hard to use despite the desire to attain user-friendliness and intuitive operation. As a result, suppliers of such products—as well as unaffiliated entities—are expected to provide help in using them. Such help is provided in a variety of ways, including:

Conventionally printed (“hardcopy”) manuals and other documentation (such as FAQs [“frequently asked questions”])

Computer-accessible (“softcopy”) documentation integrated into the product itself (a so-called “help” system) or included with the product itself (typically read on a computer screen using a browser such as Microsoft Viewer, Adobe Acrobat Reader, or a web browser such as Netscape Navigator or Microsoft Internet Explorer)

Softcopy documentation accessed via an open computer network such as the Internet or a proprietary network such as America Online (typically read in the same ways as above).

Interactive “help” with an actual person via an open or proprietary computer network (typically conducted through a “chat” session).

Telephone conversation with an actual person.

In many respects, the last two methods of providing assistance (both involving actual people) are the most desirable from the point of view of the user and least desirable from the point of view of the provider. The advantages from the point of view of the user are readily apparent, including:

The user can engage in a dialog with the help-provider, asking questions and getting answers, rather than having to search a body of material for the relevant information.

The help-provider can ask questions to help diagnose the problem.

The help-provider can guide the user through a complicated process, and can make corrections based on information provided by the user.

If the user doesn't understand an explanation the first time, the help-provider can explain it again, in a different way.

The disadvantages to the provider are perhaps not so apparent:

Recruiting, training, and maintaining a staff of help-providers is extremely expensive.

Staffing for peak demand is impractical; this leads to long waits and customer dissatisfaction during such periods.

At any staffing level, there will be periods of idleness; finding productive use for such excess capacity is difficult.

There are also other disadvantages that are probably recognized by both user and help-provider:

If the user needs to request help again at a later time, it is nearly impossible to reconnect with the same help-provider as in a previous session (or even a history of that session); as a result, both user and help-provider are often frustrated.

The abilities of help-providers will inevitably vary; ensuring a uniformly high level of quality of help provided is practically impossible.

Help procedures are necessarily standardized, and are rarely effectively varied according to the abilities and knowledge of the user.

In the face of such disadvantages and difficulties, it would seem that such interactive technical support would be an obvious candidate for automating—that is, writing a computer software program to engage in such dialog with the user. But—despite continual progress in the subdiscipline of artificial intelligence known as natural language processing—the capability to engage in an unrestricted automated dialog with a person has remained an essentially unattainable goal. This goal (known in certain contexts as the Turing Test) has been unmet (except for certain narrow special cases) for two major reasons:

In most contexts, the user may ask questions about absolutely anything. Thus, the field of knowledge the computer program must have at its command is essentially unbounded. (In all practical implementations, such information is stored in a database. In the context of artificial intelligence, such as data base is often referred to as a knowledge base)

A program that achieves only partial success has been considered a failure. Thus, if the user detects that the program is not actually a human being, this means it has failed the Turing Test.

On the other hand, despite such lack of success, there has been progress in other directly relevant areas of artificial intelligence:

Some researchers have had limited success with programs that can read newspaper stories in a narrowly defined area (for example, automobile crashes) and then answer natural-language questions about the story. (See http://www.ai.sri.com/natural-language/projects/fastus.html.)

There has been some limited success in conducting natural-language dialog (although most of such dialog has involved fooling the person, rather than actually “understanding” what the person is saying). These programs are sometimes referred to as “chatterbots.” See for example http://bots.internet.com/search/s-chat.htm.

There has been significant success in automated problem determination (or “diagnosis”). In such an application, a skilled user of the system inputs a series of data values (such as temperature, blood pressure, white blood cell counts, etc., as well as the presence or absence of a list of symptoms). The program, using pattern-recognition techniques such as decision trees, decision tables, neural nets, and nearest-neighbor technology, provides a diagnosis (and suggested course of treatment). (In some implementations, the data requested by the program depends on values input previously, so that the program only asks for information relevant to making the diagnosis.) Such automated diagnosis systems often actually perform better than a physician or other human diagnostician.

A large number of major research centers—primarily university-based—are devoted to the study of artificial intelligence, natural language processing, and automated diagnosis, including the following:

SRI International's Artificial Intelligence Center (AIC) http://www.ai.sri.com/

The University of Georgia Artificial Intelligence Center http://www.ai.uga.edu/

Brown University Department of Cognitive & Linguistic Sciences http://www.cog.brown.edu/netscape3.html

Austrian Research Institute for Artificial Intelligence (ÖFAI) http://www.ai.univie.ac.at/oefai/oefai.html

### SUMMARY OF THE INVENTION

In its primary embodiment, the present invention is a computer program to provide automated interactive technical support simulating the sort of such support an actual human being would provide, including a mechanism under which, under circumstances (described later) a human being would intervene where necessary to supplement or substitute for the automated help.

The system of the invention is not limited to technical support and is capable of handling other types of information such as customer information, e.g., account inquiries and processing; general information about an institution such as a museum, library, school etc., order processing and the like.

Other features and advantages of the present invention will become apparent from the following description of the invention which refers to the accompanying drawings.

### BRIEF DESCRIPTION OF THE DRAWINGS

FIG. 1 is a general diagrammatic layout of the various components and participants/users of the invention.

FIG. 2 is a general flow diagram of key elements of the present invention.

### DETAILED DESCRIPTION OF EMBODIMENTS OF THE INVENTION

The key idea of the invention is that it modifies conventional systems—which provide computer-based artificial intelligence and natural language processing that enable dialogue with callers or users (used interchangeably)—by including automatic or caller actuated triggers that seamlessly involve human operators in the dialogue and process of providing information or answers to callers' inquiries.

The invention attempts to exclusively engage computers in question and answer or other type of dialogue with users/callers who seek general information, answers to questions, technical assistance or the like. However, in accordance with the invention, these computers are also simultaneously engaged in an on-going process of evolving a “rating score” of the efficacy of the dialogue in terms of its success (or lack thereof) in providing the answers to questions being posed or information being solicited. If the rating of the dialogue falls below a predetermined threshold, then the system automatically connects the caller to human operators who may either provide the correct answers or direct the caller to the computer system with instructions as to how to improve the dialogue with the computer.

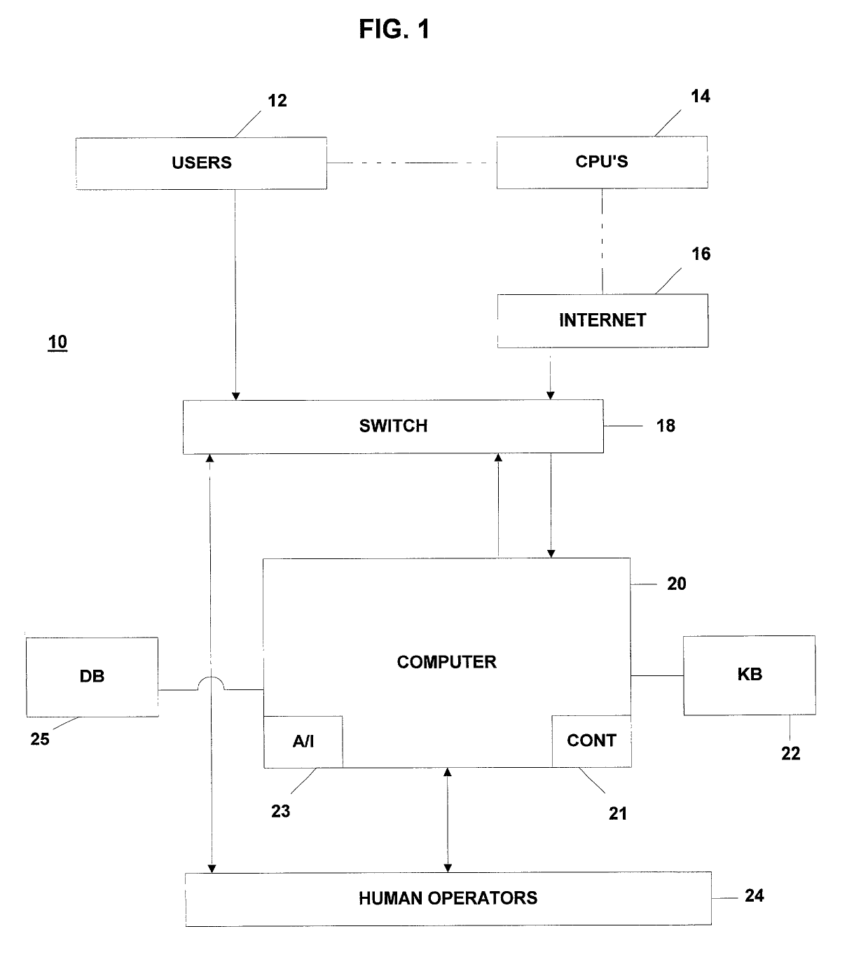

Referring to FIG. 1, the system 10 of the invention involves and implicates a universe of callers or users 12 who place calls to a computer 20 which contains control protocols 21 as well as artificial intelligence software 23 which operates in conjunction with a knowledge base 22 to allow the computer to carry-on a dialogue that strives to provide answers to callers questions, information and the like relative to predefined subjects. The dotted lines to and from the box 14 indicate that the invention provides an option that enables callers 12 to carry on a written dialogue, as by typing questions and receiving answers through their own CPUs 14, preferably via the Internet 16.

Regardless, all calls are routed to switch 18 which serves to route the callers' requests either to the computer 20 (which includes a network of computers) or, under certain circumstances, directly to human operators 24 when the computer itself or an operator determines that the intervention or knowledge or assistance of human operators 24 is appropriate or required. The key ideas and functionalities that are implemented by the system 10 of the present invention, and mainly in the computer software resident in or operable with the computer 20 and its accompanying knowledge base 22, are as follows:

The computer program simultaneously engages in automated dialog with several users.

The knowledge base is intended to be filled with a finite body of information relevant to a well-defined and limited subject matter, such as the operation of a particular computer program or web site, sufficient to handle some satisfactory percentage (for example, more than 50%) of all technical support requests.

The program monitors itself as to how well it is performing, using a variety of rating criteria. (Rating criteria will include number of unfamiliar words used by the user; number of corrections user makes to restatements made by the system; expressions of dissatisfaction by the user; etc.)

Periodically, the program restates the information it has gathered and asks for confirmation from the user. If the user does not agree that the program has accurately summarized the problem, the program decreases its self-rating, and asks for more information.

Should the rating fall below an operator-specified threshold, a signal is initiated, causing a human help-provider to intervene. (In the terminology of the invention, such an event is considered a “failure” of the automated system to provide the appropriate level of support. In the current invention, however, such a “failure” is an anticipated event whose handling is programmed into the system.) At the same time, the particular dialog is made available for display to the human help-provider.

The user (the person being given technical support) can directly request intervention by a human being, by entering any recognizable sentence implying that the user is not finding the dialog satisfactory. Such sentences (or their equivalents) would be treated in the same way as if the computer program had recognized that its performance had fallen below the required level of quality, and would be recorded as a failure.

The user's request for human intervention can also be provided via a keystroke operation, function key, mouse operation, etc., to directly request a human operator. Again, this action on the part of the user is considered a failure of the automated computer system.

Via a display, the human help-provider can monitor any of the dialogues being handled by the computer program. All or selected on-going dialogues can be listed, and one or more can be selected for display in the usual sort of “windows” provided by Microsoft Windows and other operating systems.

Optionally, the system can access data in a separate database 25, such as a database containing user information, for such purposes as acquiring configuration information, account information, charging the user for use of the system, user profile information, etc. Such information can be used to modify the behavior of the system. For example, the system can display a configuration profile and ask the user to confirm it, rather than having to ask the user to respecify his or her configuration each time. As another example, if the user is classified as an expert, the system can request that the user perform more sophisticated diagnostic actions, and the instructions can be given in terser form.

The system will record all dialogs, configuration information, diagnoses, etc., so that it will be available to the system whenever the user accesses the system again.

In its preferred embodiment, the system will make use of automated diagnosis technology by asking a series of one or more questions (accepting in response free-form answers, multiple-choice responses, or field-validated input values) and then, using prior art, making a problem determination that then suggests a response to the user.

Optionally, the system can announce itself as an automated system, or can keep the fact that it is not a human being secret.

### Extensions and Variations

The basic invention suggests a number of possible extensions and variations:

The system can provide support in a number of languages. The system can automatically determine the language from the first input of the user, or the user can explicitly request a language.

The system can be run without any online human supervision. If the dialog is deemed unsuccessful by either the system or the user, it can be terminated and a record or indication posted to a list of such dialogs. A human operator can then review the dialog at a later time and provide a response via telephone, email, or other means.

The system can be provided along with or integrated into a computer program, without any access to a human help-provider. If the dialog is unsuccessful, it suggests alternatives, such as consulting the manual or calling a technical support telephone number.

The system can be provided along with or integrated into a computer program, without any access to a human help-provider. If the dialog is unsuccessful, it sees if the user has access to the internet or other network and seeks to connect to a human help-provider via a web site or other facility.

The system can be integrated directly into a web site or computer program, so that if the user uses the web site or program incorrectly, a technical-support dialog is automatically initiated, and so that the system has convenient access to the details of the current user session.

The system can be used as the primary or optional mode of interaction with a web site or computer program, so that the user interacts with the site or program using natural language.

The system can be used as the foundation of a web site providing independent support for another web site or suite of computer programs, which the user would access separately.

The system can be used to provide information other than technical support, such as: customer information (account inquiries and processing, etc.); general information about an institution such as a museum, library, school, etc.; order processing; etc.

The system can be used to provide internal technical support (as well as other support, such as employee benefits information, policies and procedures, etc.) for a company or organization via its own internal network.

The system can be used to provide general reference information, such as that provided by an online encyclopedia, educational web site, etc.

The system can be used to handle routine email correspondence in an analogous manner, evaluating its own performance and sending those emails it cannot handle successful to a human for processing.

The system can gather statistics on how well it performs, or the circumstances in which a failure occurs, in a variety of categories (including, for example, categories based on: language of dialogue; type of problem; grammar or syntax involved; subject matter). These statistics can be used to direct the activities of those involved in maintaining the system to improve, for example, the information on a particular topic; the processing of a particular language; etc.

The system can select which support person will handle the continuation of the dialogue based on such factors as the language of the dialogue and the subject matter of the problem.

The system records the dialogue between the user and the technical support system and incorporates it into the knowledge base.

The human technical support person can, via keystroke, command, function key, etc., return control of the dialogue back to the automated system at any selected point in any dialogue.

The system can take as input a history of actual dialogues between users and technical support people and automatically derive from it the knowledge base necessary, or can use such a history to add to an existing knowledge base.

The system can take as input “help” files and other technical documentation and automatically derive from it the knowledge base necessary, or can use such technical documentation to add to an existing knowledge base.

When voice recognition technology is sufficiently advanced, the same technology can be applied to telephone call centers that provide, for example, customer support, technical support, outbound and inbound telemarketing, etc.

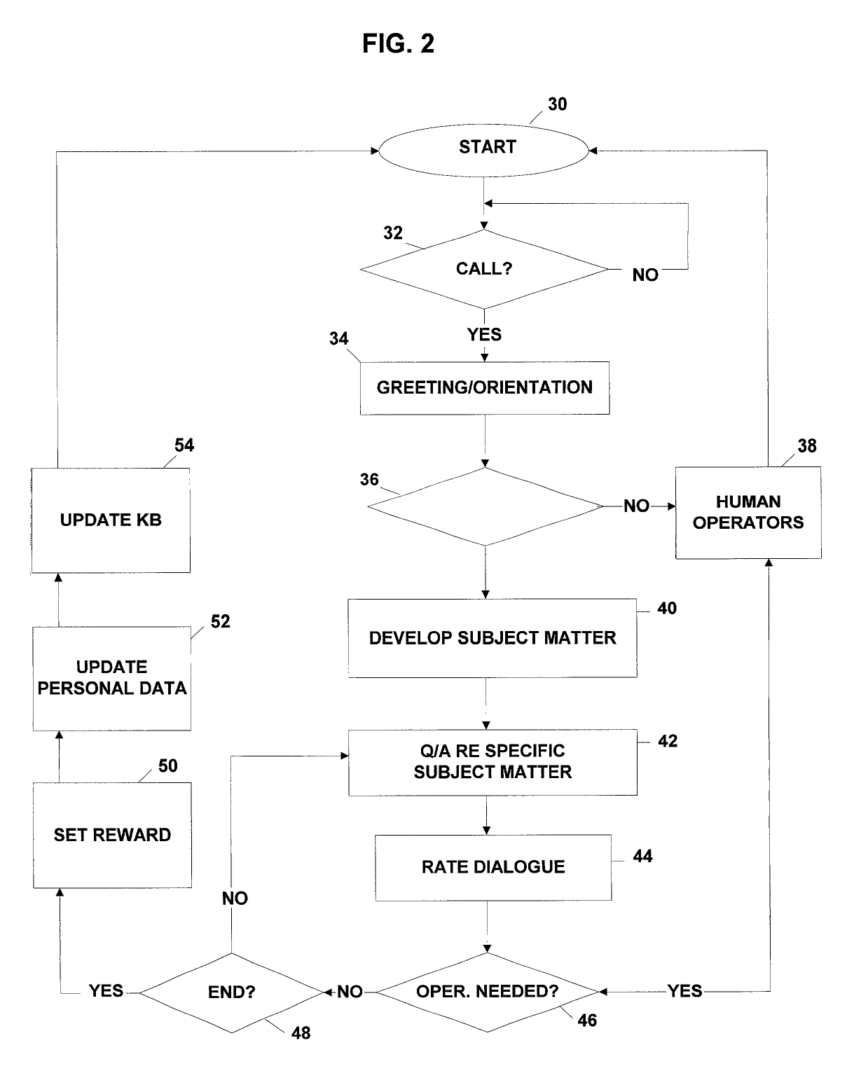

A general and simplified block diagram showing major software functionalities of the present invention is now described with reference to FIG. 2. In FIG. 2, the block 30 represents the software initiation routines comprising various housekeeping and initialization routines and the like which are required in any software program as well known by those of skill in the art. The software typically awaits calls at decision box 32. If no call is received, the software loops unto itself as indicated. However, if an incoming call has been detected, the call is answered at block 34 which contains software routines including for greeting the caller and providing various orientation messages or questions and answers designed to acquaint the caller with the nature of the software of the present invention. This software performs other functions such as identifying a caller either by asking for her name or organization and the like or by sensing through automatic number identification (ANI) the caller's identity as well as taking care of various housekeeping chores.

The software proceeds to decision block 36 which is an optional software block that asks the caller whether she insists on speaking to a human operator. It should be noted that the intention of the invention is that the caller would be urged or perhaps compelled to engage in dialogue with the computer rather than the human operator in the first instance. This can be done by providing various rewards or by insisting that the caller at least try to first obtain her or his answers through computer dialogue. If, however, human operator intervention must be provided, the program proceeds to block 38 which transfers the call to a human operator who will then strive to either provide answers to specific questions or suggest to the caller how he or she may use the substantially automated software to their benefit and advantage.

On the other hand, once the software takes over, block 40 represents the artificial intelligence software or natural language recognition routines that allow the system of the invention to initially engage in question and answer or other conversation formats designed to drill down to the most specific or best defined subject matter that the caller is interested in. Once the specific subject matter has been identified, the program proceeds to software block 42 which is designed to carry on the actual colloquy or dialogue that is intended to provide the specific answers or information desired by the caller. After each question/answer or after several such questions, the program proceeds to block 44 in which the program rates its own success in leading the caller to the specific information by various criteria which have been described above.

Subsequently, the program proceeds to decision block 46 which once again attempts to detect certain key words uttered by the caller indicative of the caller requesting a human operator or whether the automatic “rating” of the dialogue has fallen below the predetermined threshold. In either case, the system software determines that the dialogue must be turned over to the human operator, whereby the program proceeds to block 38 which has been previously described.

If, on the other hand, human intervention is not yet required, the program returns to block 48 which queries whether a satisfactory response has been provided and, if so, the call should be ended. In the case of a negative response, the software returns to block 42, continuing the process. Otherwise, the program optimally stores a reward in the user's account for having engaged and used the automated system, as indicated by block 50. Such a reward may be in the form of frequent traveler mileage or a credit toward the purchase of merchandise or the like.

The program then proceeds to block 52 where personal information regarding the caller or the organization for which the call was made is updated, for housekeeping and other purposes. As a last step, the program updates (at step 54) the knowledge base 22 to reflect knowledge gained from the just concluded question and answer session to improve the heuristics of the process so that subsequent callers may enjoy a more direct and sophisticated dialogue.

### Business Model

The invention suggests a number of sources of revenue:

The program itself is licensed to companies and organizations wishing to make interactive technical support (or other support) available via the Internet or another network. Since the objective of the system is to replace most of the human help-providers that would otherwise be necessary, the program should be licensed on the basis of maximum number of concurrent sessions.

Since the system replaces people, it should be seen as having very high value, and should command a substantial fee, which preferably would be annual rather than perpetual.

The primary market would be the major web site and proprietary networks that have non-trivial customer interaction (such as America Online, Microsoft Network, Ebay, Yahoo, etc.). A second major market would be the major software providers (such as Microsoft, IBM, Computer Associates , etc.), either to provide such support via their web sites or to provide automated “manuals” along with their products. A third major market would be the Global 2000 organizations (for their own internal support networks).

The development of the knowledge base supporting a particular program or web site is a substantial effort requiring a high level of expertise. Consulting services would provide development and maintenance of such specialized knowledge bases.

Consulting services could also be provided on installation, configuration, and integration of the system with the customer's web site or program.

The human supervision and back-up could be provided for several customers from one centralized facility.

Independent Internet help sites could be developed for the more popular web sites and computer programs. Such help sites could be accessible for a fee, or could be free and supported by advertising.

Interactive automated “manuals” could be created for the more popular computer programs (such as Microsoft Office) and sold independently.

Although the present invention has been described in relation to particular embodiments thereof, many other variations and modifications and other uses will become apparent to those skilled in the art. It is preferred, therefore, that the present invention be limited not by the specific disclosure herein, but only by the appended claims.

What is claimed is:

1. A substantially automatic and interactive system for handling requests for information from a plurality of system users, the system comprising:
a controller for responding to users information requests placed by the users;
a database containing information responsive to specific requests for information;
a computer with a memory, at least one input device and a facility that is able to retrieve information from the database that is responsive to the users' requests for information;
an artificial intelligence engine capable of carrying on a dialogue with the users and that recognizes key words and/or combinations thereof representing requests for information and that guides the computer towards specific sections of the database and that selects from the database most probable correct responses to the users' requests for information;
a dialogue rating software that qualitatively determines and sets a rating indicative of the effectiveness of the dialogue in terms of its ability to lead to the requested information; and
human intervention software that causes the dialogue to be passed to human operators in the event that the rating falls below a predetermined threshold.

2. The system of claim 1, in which the requested information comprises technical information.

3. The system of claim 1, in which the system simultaneously engages in automated dialogue with several users.

4. The system of claim 1, in which the database comprises a finite body of information relevant to a well-defined and limited subject matter.

5. The system of claim 4, in which the well-defined and limited subject matter relates to a computer program or a website.

6. The system of claim 1, in which the rating software monitors the operation of the computer in terms of how well it is performing by developing a rating criteria.

7. The system of claim 6, in which the rating criteria is based on one or more of: unfamiliar words used by the user; number of corrections a user makes to each statement made by the computer; expression of dissatisfaction by the user; and the number of questions and answers that have already transpired between a user and the computer.

8. The system of claim 1, further including a program that restates the information that a computer has gathered and asks for confirmation from the user.

9. The system of claim 1, further including a program that recognizes specific expressions by a user and treats such expressions similar to a recognition by the computer that its performance had fallen below the predetermined threshold.

10. The system of claim 1, in which a user's request for human intervention is recognizable by a non verbal command.

11. The system of claim 10, in which the non verbal command comprises one or more of a keystroke operation, a function key operation, and a mouse operation.

12. The system of claim 1, further including a visual display on which the dialogue between the users and the computer is displayed.

13. The system of claim 1, in which the database is located remotely relative to the computer.

14. The system of claim 1, further comprising software for handling personal information including account information concerning callers.

15. The system of claim 1, wherein the dialogue is maintained orally between the computer and the users.

16. The system of claim 1, further including an automated diagnostic software that asks a series of questions and accepts responses thereto.

17. The system of claim 1, wherein the system does not identify itself to users as an automated computer system.

18. The system of claim 1, in which the system is operable in a plurality of selectable languages.

19. The system of claim 1, in which the system is accessible via a website.

20. The system of claim 1, in which the information comprises information about an institution.

21. The system of claim 1, in which the information comprises general reference information of the type provided by an online encyclopedia or an educational website.

22. The system of claim 1, in which the rating software gathers statistics on how well the computer performs.

23. The system of claim 22, in which the statistics are gathered relative to failures that have occurred based on a plurality of different criteria.

24. The system of claim 1, further including software for maintaining and storing a history of actual dialogues between users and the system.

25. The system of claim 24, in which information from the history being maintained is used to supplement an existing database.
